(19) United States
(12) Patent Application Publication
(10) Pub. No.: US 2005/0211917 A1
(43) Pub. Date: Sep. 29, 2005

(54) Radiation image storage panel

(75) Inventors: Shinichiro Fukui, Ashigara-kami-gun (JP); Hideki Suzuki, Ashigara-kami-gun (JP); Hiroki Saito, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/091,471

(22) Filed: Mar. 29, 2005

(30) Foreign Application Priority Data
Mar. 29, 2004 (JP) 2004-097173

(51) Int. Cl. G21K 4/00

(52) U.S. Cl. 250/484.4

(57) ABSTRACT

A radiation image storage panel has a phosphor layer containing an energy-storing phosphor and a protective film arranged on one side of the phosphor layer in which the protective film has a surface of a universal hardness of 53 N/mm² or more, a surface roughness Ra in the range of 0.10 to 0.50 μm, and a thickness in the range of 1 to 40 μm.

### FIELD OF THE INVENTION

The present invention relates to a radiation image storage panel employable in a radiation image recording and reproducing method in which an energy-storing phosphor is utilized.

### BACKGROUND OF THE INVENTION

When exposed to radiation such as X-rays, an energy-storing phosphor (e.g., stimulable phosphor, which gives stimulated emission off) absorbs and stores a portion of the radiation energy. The phosphor then emits stimulated emission according to the level of the stored energy when it is exposed to a stimulating light. A radiation image recording and reproducing method utilizing the energy-storing phosphor has been widely employed in practice. In that method, a radiation image storage panel, which is a sheet comprising the energy-storing phosphor, is used. The method comprises the steps of: exposing the storage panel to radiation having passed through an object or having radiated from an object, so that radiation image information of the object is temporarily recorded in the panel; sequentially scanning the storage panel with a stimulating light such as a laser beam to emit stimulated light; and photoelectrically detecting the emitted light to obtain electric image signals. The storage panel thus treated is subjected to a step for erasing radiation energy remaining therein, and then stored for the use in the next recording and reproducing procedure. Thus, the radiation image storage panel can be repeatedly used.

The radiation image storage panel (sometimes referred to as “energy-storing phosphor sheet”) has a basic structure comprising a support and an energy-storing phosphor layer provided thereon. However, if the phosphor layer is self-supporting, the support may be omitted. Further, a protective film is generally provided on the free surface (surface not facing the support) of the phosphor layer to keep the phosphor layer from chemical deterioration or physical damage.

The phosphor layer generally comprises a polymer binder and an energy-storing phosphor dispersed therein. A phosphor layer containing no polymer binder is also known. The phosphor layer containing no polymer binder can be formed by a vapor phase deposition method.

The radiation image recording and reproducing method (or radiation image forming method) has various advantageous features as described above. It is still desired, however, that the radiation image storage panel used in the method have a sensitivity as high as possible and, at the same time, give a reproduced radiation image of high quality (in regard to sharpness and graininess).

Japanese Patent Provisional Publication 2000-346996 discloses a radiation image storage panel having a protective film which has a surface roughness Ra satisfying the condition of 0.10 μm≦Ra≦0.45 μm and describes that this radiation image storage panel shows a high resistance to physical damages such as abrasion and scratch without lowering quality of the reproduced radiation image.

Japanese Patent Provisional Publication 2002-286895 discloses a radiation image storage panel comprising a support, an a stimulable phosphor layer and a moisture resistant protective film enclosing both of the support and the phosphor layer in which the protective film has a surface roughness Ra on its outer surface satisfying the condition of 0.10 μm≦Ra≦1.00 μm and a Sm value in the range of 50 to 500 μm and the phosphor layer has a surface roughness Rt satisfying the condition of 0.10 μm≦Ra≦2.50 μm, and describes that this radiation image storage panel gives a reproduced radiation image having improved sharpness and no image unevenness. Ra is a center line average roughness (cut off level: 0.08 mm) measured according to JIS B 0G01, Rt means a maximum height roughness defined in JIS B 0601, and Sm is a mean distance between concaves and convexes measured according to JIS B 0601 (cut off level: 0.8 mm).

### SUMMARY OF THE INVENTION

The radiation image storage panel is required to give a reproduced radiation image having high image quality. However, if a radiation image storage panel having received physical damages such as abrasion and scratch on its surface from which the stored radiation image is read is employed in the radiation image storing and reproducing method, the reproduced radiation image sometimes shows artifacts to cause an error in diagnosis. Therefore, it is desired that the radiation image storage panel is highly resistant to physical damages such as abrasion and scratch and also gives a reproduced radiation image having high quality.

Accordingly, it is an object of the invention to provide a radiation image storage panel having a high resistance to physical damages and giving a reproduced radiation image of high quality.

It is an another object of the invention to provide a radiation image storage panel that is favorably employable for clinical diagnosis.

The present inventors have studied a radiation image storage panel for examining a relationship between the resistance to physical damages and the image quality of a radiation image reproduced by the use thereof. As a result, they have found that the adjustment of surface roughness of the protective film is not enough for imparting an appropriate resistance to physical damages to the radiation image storage panel and may lower the image quality reproduced by the use of the storage panel.

A further study performed by the inventors has revealed that an appropriate adjustment of a surface hardness and a film thickness of the protective film in combination with the adjustment of surface roughness of the protective film can give a radiation image storage panel having an appropriate resistance to physical damages and giving a reproduced radiation image of high quality.

Accordingly, the present invention resides in a radiation image storage panel comprising an energy-storing phosphor layer and a protective film arranged on one side of the phosphor layer in which the protective film has a surface of a universal hardness of 53 N/mm² or more, a surface roughness Ra in the range of 0.10 to 0.50 μm, and a thickness in the range of 1 to 40 μm.

In the invention, the universal hardness means a hardness HU defined in DIN 50359 and ISO 14577. The surface roughness (Ra) is a center line average roughness) defined in JIS B 0601.

Preferred embodiments of the invention are described below,
(1) The universal hardness of the protective film is 55 N/mm² or more.

(2) The radiation image storage panel shows a deflection of less than 20 mm which is determined under such condition that the storage panel is supported at a line apart from one side of the storage panel by 20 cm.

(3) The phosphor layer comprises the energy-storing phosphor in the form of phosphor particles and a polymer binder and contains the phosphor particles 65 vol. % therein.

(4) A ratio of a content of the polymer binder to a content of the phosphor particles in the phosphor layer is not more than 1/25.

(5) The phosphor layer has a thickness of 250 μm or more.

(6) The phosphor layer has a light-reflecting layer on the side opposite the side on which the protective film is arranged, and the light-reflecting layer shows a light reflectance of 70% or more at a wavelength corresponding to a peak wavelength of an emission spectrum of the energy-storing phosphor.

### BRIEF DESCRIPTION OF DRAWING

FIG. 1 is a sectional view schematically illustrating an example of the structure of a radiation image storage panel according to the invention.

FIG. 2 is a sectional view schematically illustrating a representative structure of a radiation image storage panel according to the invention.

FIG. 3 is a sectional view schematically illustrating another structure of a radiation image storage panel according to the invention.

FIG. 4 is a sectional view schematically illustrating a still another structure of a radiation image storage panel according to the invention.

### DETAILED DESCRIPTION OF THE INVENTION

In the following description, the radiation image storage panel of the invention is explained in detail, referring to the attached drawings.

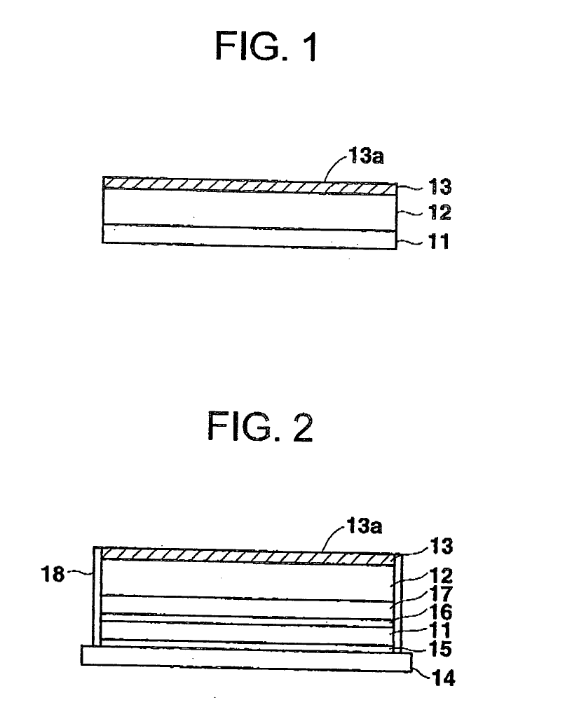

FIG. 1 schematically shows an example of the structure of radiation image storage panel according to the invention. The radiation image storage panel comprises a support 11, a phosphor layer 12 and a protective film 13 which are arranged in order.

FIG. 2 schematically shows a representative structure of radiation image storage panel according to the invention. The radiation image storage panel comprises a second support 14, an adhesive layer 15, a first support 11, an electro-conductive layer 16, a light-reflecting layer 17, a phosphor layer 12, and a protective film which are arranged in order. The peripheral area is coated with a peripheral coat 18.

In the invention, the protective film 13 has a surface 13a that has a universal hardness (i.e., hardness HU defined in DIN 50359 and ISO 14577) of 53 N/mm² or more (generally less than 70 N/mm²) and a surface roughness Ra in the range of 0.10 to 0.50 μm. The universal hardness is defined as a value obtained by multiplying an applied force (F) by a surface area A(h) of the produced indent. In more detail, a Vickers indenter is pressed onto the protective film by means of a mini-scale hardness meter (Fischer's Scope H100C) under the conditions of a force (F) of 100 mN and a pressing period of 50 sec., and a depth (h) of the indent is measured. HU is obtained from F and A(h) according to the following formula (1), and the surface area A(h) is obtained from the depth (h) of indent according to the following formula (2):
HU=F/A(h)=F/(26.43×h²) (1)
A(h)=4×sin(α/2)/cos²(α/2)×h(α=136°) (2)

The protective film 13 further has a surface roughness Ra in the range of 0.10 to 0.50 μm, preferably 0.12 to 0.30 μm, and a thickness in the range of 1 to 40 μm, preferably 2 to 20 μm.

The protective film of the radiation image storage panel of the invention is highly resistant to physical damages such as abrasion and scratches. Even when the protective film is given abrasion and scratches, the abrasion and scratches do not significantly lower image quality of the reproduced radiation image.

The radiation image storage panel preferably shows a deflection of less than 20 mm, more preferably less than 10 mm, which is determined under such condition that the storage panel is supported at a line apart from one side of the storage panel by 20 cm. The less deflection can be given to the radiation image storage panel, for instance, by providing a second support 14 of hard material to the reverse surface of the first support 11. Thus produced hard and rigid radiation image storage panel having less flexibility can be easily handled and is resistant to physical damages.

The phosphor layer 12 preferably comprises particles of the energy-storing phosphor and a polymer binder. In order to improve image quality of the reproduced radiation image, the phosphor layer preferably has a volume ratio of the phosphor particles of 65% or more, more preferably 70% or more. Further, from the view point of the image quality, the polymer binder is comprised in the phosphor layer in a weight ratio (polymer binder/phosphor particles) of 1/25 or less. The thickness of the phosphor layer preferably is not less than 250 μm so that the radiation such as X-rays can be sufficiently absorbed by the phosphor layer.

Further, from the view point of the image quality, the phosphor layer 12 has a light-reflecting layer 17 on one surface, which shows a light reflectance of 70% or more at a wavelength corresponding to a peak wavelength of an emission spectrum of the energy-storing phosphor. The provision of the light-reflecting layer enhances an efficiency of recovering the stimulated emission from the phosphor layer.

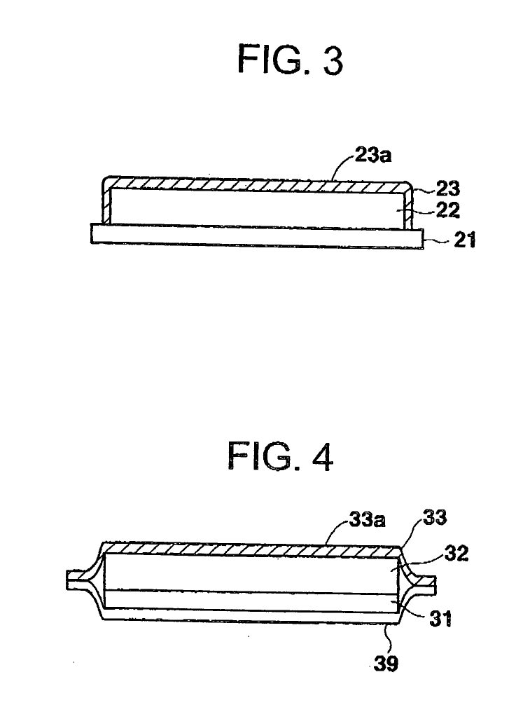

The protective film 13 can be a single layer film or a film comprising two or more layers. The protective film can be in the form of a film 23 illustrated in FIG. 3 of a radiation image storage panel comprising a support 21, a phosphor layer 22 and a protective film 23 having a surface 23a of an appropriate roughness, in which the protective film 23 covers not only the upper surface of the phosphor layer 22 but also the peripheral area of the phosphor layer 22.

Otherwise, the radiation image storage panel can comprises, as is illustrated in FIG. 4, a bottom side protective film 39, a support 31, a phosphor layer 32, and a top side protective film 33 having a surface 33a of an appropriate roughness. The top side protective film 33 and the bottom side protective film 39 are combined to each other at their peripheral areas and completely seal the phosphor layer.

The radiation image storage panel of the invention can have a different structure, such as, having one or more auxiliary layers.

The radiation image storage panel of the invention can be manufactured in the following manner using the following materials.

The support generally is a soft resin sheet or film having a thickness of 50 μm to 1 mm. The support may be transparent, may contain light-reflecting material (e.g., particles of alumina, titanium dioxide and barium sulfate) or voids for reflecting the stimulating light or the stimulated emission, or may contain light-absorbing material (e.g., carbon black) for absorbing the stimulating light or the stimulated emission. Examples of the resin materials employable for the support include polyethylene terephthalate, polyethylene naphthalate, aramide resin and polyimide resin. For improving the sharpness of the reproduced radiation image, fine protrusions and indents may be formed on the phosphor layer-side surface of the support (or on the phosphor layer-side surface of an auxiliary layer such as a subbing layer, a light-reflecting layer, or a light-absorbing layer, if it is provided). The support may be a sheet of metal, ceramics, or glass.

The support can have a second support made of a rigid and lightweight material (e.g., carbon fiber sheet) on a side on which neither a phosphor layer nor a light-reflecting layer is provided.

It is preferred to provide an adhesive layer to enhance the adhesion between the support and the phosphor layer or a light-reflecting layer. Examples of resin materials employable for forming the adhesive layer include polyester resin, acryl resin, polyurethane resin, polyvinyl butyral, polyvinyl acetate, vinylidene chloride-vinyl chloride copolymer.

It is preferred to place a light-reflecting layer on the support. The light-reflecting layer generally comprises particles of light-reflecting material and a polymer binder dispersing and supporting the particles.

The light-reflecting layer scatters a stimulating light preferably under such condition that the scattering length can be preferably 5 μm or less, more preferably 4 μm or less. The “scattering length” means an average distance in which a stimulating light travels until it is scattered, and hence a short scattering length indicates that the stimulating light is highly scattered. The scattering length can be calculated based on Kubeluka-Munk theory.

Examples of the light-reflecting materials include white pigments such as Al₂O₃, ZrO₂, TiO₂, MgO, BaSO₄, SiO₂, ZnS, ZnO, CaCo₃, Sb₂O₂, Nb₂O₅, 2PbCO₃.Pb(OH)₂, PbF₂, BiF₃, Y₂O₃, YOCl, M¹¹FX (in which M¹¹ is at least one selected from the group consisting of Ba, Sr and Ca; and X is at least one selected from the group consisting of Cl and Er), lithopone (BaSO₄ and ZnS), magnesium silicate, basic lead silicate sulfate, basic lead phosphate, and aluminum silicate; and hollow polymer. They may be used singly or in combination. Particularly preferred are Al₂O₃, Y₂O₃, ZrO₂ and TiO₂, which have such a high refractive index that the scattering length of the reflecting layer can be easily made 5 μm or shorter.

In order to prepare the light-reflecting layer giving the short scattering length, the particles of light-reflecting material may be made to have a diameter as close as possible to the wavelength of the stimulating light and/or made to have not a spherical shape but a deformed one. In detail, the mean size of the particles is preferably ¼ to 2 times as large as the stimulating wavelength. In other words, the mean size of the particles preferably is in the range of 0.1 to 2.0 μm because the stimulating light is generally in the wavelength range of 500 to 800 nm.

The BET specific surface area (surface area per unit mass) of the light-reflecting material generally is 1.5 m²/g or more, preferably in the range of 2 to 10 m²/g, more preferably in the range of 2.5 to 8 m²/g. The bulk density (closest packing density) of the reflecting material preferably is 1 mg/cm³ or less, more preferably 0.6 mg/cm³ or less. The bulk density (closest packing density) can be determined by the steps of weighing a powder of the light-reflecting material, shaking the powder to fill voids therein so that the powder may be packed closest, measuring the volume of the closest packed powder, and calculating a ratio of the weight to the volume.

The light-reflecting material in the form of fine particles having the above characters is incorporated into the light-reflecting layer, and thereby many voids are formed in the reflecting layer. Because of thus-formed voids, the reflecting layer can have such a high refractive index that a short scattering length can be given without aggregating the particles.

The light-reflecting layer can be formed by the steps of preparing a coating solution in which fine particles of light-reflecting material and a binder are dissolved or dispersed in an organic solvent, evenly coating the surface of the support (or the adhesive layer) with the coating solution, and drying the coated solution. The weight ratio of the binder to the light-reflecting material in the coating solution is generally in the range of 1/10 to 1/50, preferably in the range of 1/10 to 1/20. The thickness of the light-reflecting layer is generally in the range of 5 to 100 μm.

On the light-reflecting layer, a phosphor layer comprising an energy-storing phosphor is provided. In consideration of the image quality, the phosphor layer preferably scatters the stimulating light and the stimulated emission so that the scattering length can be adjusted in the range of 5 to 20 μm.

The energy-storing phosphor preferably is a stimulable phosphor giving stimulated emission off in the wavelength region of 300 to 500 nm when it is exposed to a stimulating light in the wavelength region of 400 to 900 nm. Preferred examples of the stimulable phosphors include europium or cerium activated alkaline earth metal halide stimulable phosphors [e.g., BaFBr:Eu and BaF(Br, I):Eu] and cerium activated rare earth oxyhalide phosphors.

Particularly preferred is a rare earth activated alkaline earth metal fluoride halide stimulable phosphor represented by the formula (I):
M^{II}FX:zLn (I)
in which M^{II} is at least one alkaline earth metal selected from the group consisting of Ba, Sr and Ca; Ln is at least one rare earth element selected from the group consisting of Ce, Pr, Sm, Eu, Tb, Dy, Ho, Nd, Er, Tm and Yb; X is at least one halogen selected from the group consisting of Cl, Br and I; and z is a number satisfying the condition of 0<z≦0.2.

In the formula (I), M^{II} preferably comprises Ba more than half of the total amount of M^{II}, and Ln is preferably Eu or Ce. The M^{II}FX in the formula (I) represents a matrix crystal structure of BaFX type, and it by no means indicates stoichiometrical composition of the phosphor. Accordingly, a molar ratio of F:X is not always 1:1. It is generally preferred that the BaFX type crystal have many F⁺(X⁻) centers corresponding to vacant lattice points of X⁻ ions since they increase the efficiency of stimulated emission in the wavelength region of 600 to 700 nm. In that case, F is often slightly in excess of X.

Although omitted from the formula (I), one or more additives such as bA, wN^{I}, xN^{II} and yN^{III} may be incorporated into the phosphor of the formula (I), if needed. In the above, A stands for a metal oxide such as Al₂O₃, SiO₂ or ZrO₂. In order to prevent M^{II}FX particles from sintering, the metal oxide preferably has low reactivity with M^{II}FX and the primary particles of the oxide are preferably super-fine particles of 0.1 μm or less diameter. In the above-mentioned description, N^{I} is a compound of at least one alkali metal selected from the group consisting of Li, Na, K, Rb and Cs; N^{II} is a compound of alkaline earth metal(s) Mg and/or Be; and N^{III} is a compound of at least one trivalent metal selected from the group consisting of Al, Ga, In, Tl, Sc, Y, La, Gd and Lu. The metal compounds are preferably halides.

In the above-mentioned description, b, w, x and y represent amounts of the additives incorporated into the starting materials, provided that the amount of M^{II}FX is assumed to be one mol. They are numbers satisfying the conditions of 0≦b≦0.5, 0≦w≦2, 0≦x≦0.3 and 0≦y≦0.3, respectively. These numbers by no means represent the contents in the resultant phosphor because the additives often decrease during the steps of firing and washing performed thereafter. Some additives remain in the resultant phosphor as they are added to the starting materials, but the others react with M^{II}FX or are involved in the matrix.

In addition, the phosphor of the formula (I) may further comprise Zn and Cd compounds; metal oxides such as TiO₂, BeO, MgO, CaO, SrO, BaO, ZnO, Y₂O₃, La₂O₃, In₂O₃, GeO₂, SnO₂, Nb₂O₅, Ta₂O₅ and ThO₂; Zr and Sc compounds; B compounds; As and Si compounds; tetrafluoro-borate compounds; hexafluoro compounds such as monovalent or divalent salts of hexa-fluorosilicic acid, hexafluoro-titanic acid and hexa-fluorozirconic acid; or compounds of transition metals such as V, Cr, Mn, Fe, Co and Ni. The phosphor employable in the invention is not restricted to the above, and any phosphor that can be essentially regarded as rare earth activated alkaline earth metal fluoride halide stimulable phosphor can be used.

The stimulable phosphor represented by the formula (I) generally is in the form of particles having an aspect ratio of 0.1 to 5.0. The particles of the energy-storing phosphor in the invention have an aspect ratio of preferably 0.1 to 5.0 (more preferably 1.0 to 1.5). In their size distribution, the median diameter (Dm) preferably is in the range of 2 to 10 μm (more preferably 2 to 7 μm) and the σ/Dm (in which σ represents the standard deviation) preferably is 50% or less (more preferably 40% or less). The shape of the particle is rectangular parallelepiped, regular hexahedron, regular octahedron, tetradecahedron, intermediate polyhedron thereof, or irregular shape. Preferred is tetradecahedron.

The phosphor employable in the invention is not restricted to the above-described stimulable phosphor represented by the formula (I).

The phosphor particles preferably is a mixture of two or more groups of phosphor particles having different particle size distributions from the view point of improving the image quality (e.g., graininess) of the reproduced radiation image. A group of phosphor particles comprising a relatively small particle size distribution preferably has a mean particle size Dmₐ (median diameter) in the range of 1.0 to 3.5 μm. A ratio of Dm_{b}/Dmₐ preferably is not less than 2.0 wherein Dm_{b} means a median diameter of a group of phosphor particles comprising a relatively large particle size distribution. The mixture preferably comprises the group of phosphor particles comprising a relatively small particle size distribution in a range of 10 to 50 wt. %, while the group of phosphor particles comprising a relatively large particle size distribution in a range of 50 to 90 wt. %.

The phosphor layer can be formed, for example, in the following manner. First, the phosphor particles (which preferably is a mixture of two or more groups having different particle size distribution) and a polymer binder are dispersed or dissolved in an appropriate organic solvent to prepare a phosphor dispersion. A weight ratio between the polymer binder and the phosphor in the solution generally is in the range of 1:1 to 1:100 (binder:phosphor, by weight), preferably 1:25 to 1:50.

As the binder dispersing and supporting the phosphor particles, various resin materials are generally known. Examples of the binder include natural polymers such as proteins (e.g., gelatin), polysaccharides (e.g., dextran) and gum arabic; and synthetic polymers such as polyvinyl butyral, polyvinyl acetate, nitrocellulose, ethyl cellulose, vinylidene chloride-vinyl chloride copolymer, polyalkyl (meth)acrylate, vinyl chloride-vinyl acetate copolymer, polyurethane, cellulose acetate butyrate, polyvinyl alcohol, linear polyester, and thermoplastic elastomers. These may be cross-linked with a crosslinking agent.

Examples of the solvents employable in preparation of the coating solution for the phosphor layer include lower aliphatic alcohols such as methanol, ethanol, n-propanol and n-butanol; chlorinated hydrocarbons Such as methylene chloride and ethylene chloride; ketones such as acetone, methyl ethyl ketone and methyl isobutyl ketone; esters of lower aliphatic alcohols with lower aliphatic acids such as methyl acetate, ethyl acetate and butyl acetate; ethers such as dioxane, ethylene glycol monoethyl ether, ethylene glycol monomethyl ether and tetrahydrofuran; and mixtures thereof.

The phosphor dispersion may contain various additives such as a dispersing aid to assist the phosphor particles in dispersing, a plasticizer for enhancing the bonding between the binder and the phosphor particles, an anti-yellowing agent for preventing the layer from undesirable coloring, a hardening agent, and a crosslinking agent.

The phosphor dispersion is then evenly spread on the surface of the light-reflecting layer and dried to form the phosphor layer. The thickness of the phosphor layer generally is in the range of 20 μm to 1 mm, preferably in the range of 250 to 500 μm.

Thus formed phosphor layer may be compressed by means of, for example, a calender. By the compression, the packing density of the energy-storing phosphor layer can be increased to 65 vol. % or more, to give a short scattering length.

The phosphor layer may be a single layer or may consist of two or more sub-layers. The sub-layers may have different compositions. For example, they may differ in the phosphor (in regard to the compound or the particle size) or in the ratio between the phosphor and the binder. In other words, the sub-layers can be optimally designed so that the emission characteristics of the phosphor layer may suit the use of the storage panel or that a suitable scattering length may be obtained. Further, it is not necessary to form the phosphor layer directly on the light-reflecting layer. For example, the phosphor layer beforehand formed on a different substrate (temporary support) may be peeled off and then fixed onto the light-reflecting layer of the genuine support with an adhesive.

On the phosphor layer, a protective film is provided to ensure good handling of the storage panel in transportation and to avoid deterioration. As is described hereinbefore, the protective film of the radiation image storage panel of the invention has specific surface roughness, universal hardness and thickness. The protective film preferably is transparent so as not to prevent the stimulating light from coming in or not to prevent the emission from coming out. Further, for protecting the storage panel from chemical deterioration and physical damage, the protective film is preferably chemically stable, physically strong, and of high moisture proof.

The protective film can be provided by coating the phosphor layer with a solution in which a transparent organic polymer (e.g., cellulose derivatives, polymethyl methacrylate, fluororesins soluble in organic solvents) is dissolved in an appropriate solvent, by placing a beforehand prepared sheet as the protective film (e.g., a film of organic polymer such as polyethylene terephthalate) on the phosphor layer with an adhesive, or by depositing vapor of inorganic compounds on the phosphor layer. Various additives may be contained in the protective film. Examples of the additives include light-scattering fine particles (e.g., particles of magnesium oxide, zinc oxide, titanium dioxide and alumina), a slipping agent (e.g., powders of perfluoroolefin resin and silicone resin) and a crosslinking agent (e.g., polyisocyanate). The thickness of the protective film preferably is in the range of 2 to 20 μm.

For enhancing resistance to stain, a fluororesin layer may be placed on the protective film. The fluororesin layer can be formed by coating the surface of the protective film with a solution in which a fluororesin is dissolved (or dispersed) in an organic solvent, and by drying the applied solution. The fluororesin may be used singly, but a mixture of the fluororesin and a film-forming resin is generally employed. In the mixture, an oligomer having polysiloxane structure or perfluoro-alkyl group can be further added. In the fluororesin layer, fine particle filler may be incorporated to reduce blotches caused by interference and to improve quality of the resultant image. The thickness of the fluororesin layer generally is in the range of 0.5 to 20 μm. For forming the fluororesin layer, additives such as a crosslinking agent, a film-hardening agent and an anti-yellowing agent can be used. In particular, the crosslinking agent is advantageously employed to improve durability of the fluororesin layer.

The surface of the protective film is preferably processed to adjust the surface roughness in the specific range, for instance, by placing an embossing roll under pressure to form a pattern comprising a great number of small protrusions and indents.

The storage panel of the invention can be in known various structures. For example, in order to improve the sharpness of the reproduced radiation image, at least one of the sheets, layers or films may be colored with a colorant which does not absorb the stimulated emission but the stimulating light. Further, one more phosphor layer comprising a phosphor which absorbs radiation and instantly emits ultraviolet or visible light may be provided. Examples of that phosphor include phosphors of LnTaO₄:(Nb, Gd) type, Ln₂SiO₅:Ce type and LnOX:Tm type (Ln is a rare earth element); CsX (X is a halogen); Gd₂O₂S:Tb; Gd₂O₂S:Pr,Ce; ZnWO₄; LuAlO₃:Ce; Gd₃Ga₅O₁₂:Cr,Ce; and HfO₂.

In the above description, the radiation image storage panel of the invention is explained, by way of example, in the case where the energy-storing phosphor layer is formed by coating with a coating solution containing a binder and phosphor particles dispersed therein. However, it is known that the phosphor layer containing an energy-storing phosphor can be prepared by a gas-phase accumulation method. The radiation image storage panel of the invention may have an energy-storing phosphor layer formed by such or other known methods.

The present invention is further described by the following examples.

### EXAMPLE 1

(1) Preparation of phosphor sheet
Tetradecahedral stimulable phosphor particles
(BaF(Br_{0.85}I_{0.15}): Eu²⁺,

| | |
|---|---|
| Group I (mean particle size Dm: 7.2 μm) | 175 g |
| Group II (mean particle size Dm: 2.4 μm) | 75 g |
| Binder: HDI polyurethane elastomer | 7.1 g |
| [Pandex T5265H, solid, Dainippon Ink & | |
| Chemicals, Inc.] | |
| Crosslinking agent: HDI polyisocyanate resin | 0.90 g |
| [Colonate HX (solid content: 100%), | |
| Nippon Polyurethane Co., Ltd.] | |
| Anti-yellowing agent: Epoxy resin | 2.0 g |
| [Epikote #1001 (solid), Yuka Shell Epoxy] | |
| Colorant: Ultramarine blue [SM-1, Daiich Kasei | 0.022 g |
| Industries Co., Ltd.] | |

The above-mentioned materials were placed in methyl ethyl ketone (MEK), and stirred at 2,500 rpm (circumferential speed: 18 m/sec.) under cooling for 2 hours to prepare a phosphor dispersion having a viscosity of 3 Pa·s (binder/phosphor: 1/25, by weight). Independently, a polyethylene terephthalate sheet (temporary support, thickness: 190 μm) beforehand coated with a silicone releasing agent was prepared. The phosphor dispersion was then spread on the releasing agent-coated surface of the temporary support by means of a coating machine to give a coated dispersion layer having a width of 400 mm, and dried to form a phosphor layer. The phosphor layer was then separated from the temporary support to obtain a phosphor sheet.

(2) Preparation of Electro-Conductive Layer

Electro-conductive material: Sb-doped SnO₂ acicular

(2) Preparation of electro-conductive layer

| | |
|---|---|
| Electro-conductive material: Sb-doped SnO₂ acicular | 50 g |
| fine particles (length: 0.2-2 μm, width: 0.01-0.02 μm, | |
| FS-10P, Ishihara Sangyo Co., Ltd., | |
| MEK dispersion, solid content: 30 wt. %] | |
| Resin: Saturated polyester resin (Byron 300, | 6 g |
| Toyobo Ltd.) | |
| Curing Agent: Polyisocyanate (Olester NP38-70S, | 2 g |
| solid content: 70%, Mitsui Chemical Co., Ltd.) | |

The above-mentioned material were mixed in MEK and dispersed to give a dispersion having a viscosity of 0.02 to 0.05 Pa·s. The dispersion was then coated on a surface of a polyethylene terephthalate (PET) sheet (first support, thickness: 188 μm, Haze: approx. 27, Lumilar S-10, Toray Company, Ltd.) by a doctor blade and dried to form an electro-conductive layer (thickness: 2 μm).

(3) Formation of light-reflecting layer

| | |
|---|---|
| Light-reflecting material: Fine particles of | 444 g |
| extra-pure alumina [mean size: 0.4 μm, | |
| UA-5105, Showa Denko K.K.] | |
| Binder: Soft acryl resin | 100 g |
| [Criscoat P-1018GS (20% toluene solution), | |
| Dai-nippon Ink & Chemicals, Inc.] | |
| Colorant: Ultramarine blue | 2.2 g |
| [SM-1, Daiichi Chemical | |
| Industry Co.,, Ltd.] | |

The above-mentioned materials were mixed in MEK, and dispersed to prepare a dispersion having a viscosity of 2 to 3 Pa·s. The dispersion was spread on the electroconductive layer by means of a doctor blade, and dried to form a light-reflecting layer (thickness: approx. 100 μm). The light-reflecting layer showed a reflectance of 98% at a wavelength corresponding to a peak wavelength (400 nm) of an emission spectrum of the phosphor.

(4) Formation of Phosphor Layer (Compression Under Heating)

The phosphor sheet was placed on the light-reflecting layer of the first support so that the bottom face of the phosphor sheet (surface having been in contact with the temporary support when the phosphor sheet was prepared) would be in contact with the light-reflecting layer. Thus formed laminate was then compressed under heating by means of a calender roll (metal rolls, roll diameter: 200 mm, temperature of the upper roll: 45° C., temperature of the lower roll: 45° C., transferring rate; 0.3 m/min.), so that the phosphor sheet was compressed and completely combined with the light-reflecting layer.

(5) Formation of protective film

| | |
|---|---|
| Polymer material: Fluoroolefin-vinylether copolymer | 92.5 g |
| [Lumiflon LF-504X (30% xylene solution), | |
| Asahi Glass Co., Ltd.] | |
| Crosslinking agent: Polyisocyanate | |
| [Sumijule N3500 (non-nolatile component content: | 5.0 g |
| 100%), Sumitomo Bayer Urethane, Inc.] | |
| Slipping agent: Alcohol modified silicone (X-22-2809, | 0.5 g |
| non-volatile component content: 66%, | |
| xylene-containing paste, Shin-etsu | |
| Chemical Company Ltd.] | |
| Filler: Melamine-formaldehyde resin fine particles | 6.5 g |
| [mean diameter: 0.6 μm, Eposter S6, Nippon | |
| Catalyst Company Ltd.] | |
| Coupling agent: Acetoalkoxyaluminum isopropylate, | 0.1 g |
| Plainact Al-M, Ajinomoto Co., Ltd.] | |
| Catalyst: dibutyl tin dilaurate | 0.35 mg |
| [KS1260, Kyodo Yakuhin Co., Ltd.] | |

The above-mentioned materials were mixed in MEK and dispersed to prepare a polymer dispersion. The polymer dispersion was spread on a PET film (thickness: 6 μm, Lumilar 6C-F53, Toray Company, Ltd.) and dried to give a coated layer (thickness: 2 μm). On an opposite surface of the PET film having the coated layer, an adhesive layer was formed by coating a solution of saturated polyester resin (Byron 30 SS, Toyobo Company Ltd.) and drying the coated layer. Thus prepared film was placed on the phosphor layer via the adhesive layer by means of a laminator roll to give a protective film (thickness: 8 μm).

The surface of the protective film was processed by applying an embossing roll having a pattern of small protrusions and indents under pressure at 50° C., to impart a surface roughness Ra of 0.20 μm to the protective film.

(6) Formation of Side Coat

The composite structure manufactured above was cut to give a sheet (430 mm×354 mm). The sheet was coated with a fluororesin solution at its peripheral area to give a coated layer having a thickness of 1 mm and dried to give the side coat.

(7) Provision of Second Support

A second support comprising a pair of carbon fiber sheet and an intervening foamed resin material (440 mm×364 mm, thickness: 4.5 mm, weight: 330 g) was combined onto the bottom surface of the first support of the sheet using a double-sided adhesive tape.

Thus, a radiation image storage panel having a structure of FIG. 2 and according to the invention was manufactured.

### EXAMPLE 2

The procedures of Example 1 were repeated except that the following modifications were made.

In the preparation of phosphor sheet (1), the following phosphor particles were employed:

Tetradecahedral stimulable phosphor particles (BaF(Br_{0.85}I_{0.15}):Eu²⁺,

Group I (mean particle size Dm: 8.0 μm) 225 g
Group II (mean particle size Dm: 2.4 μm) 75 g

In the formation of protective film (5), a polymer dispersion of the following composition was directly coated on the phosphor layer and dried to give a protective film (thickness: 3 μm), and the protective film was processed by an embossing roll to have a surface roughness of 0.15 μm.

| | |
|---|---|
| Polymer material: Fluoroolefin-vinylether copolymer | 92.5 g |
| [Lumiflon LF-504X (30% xylene solution), | |
| Asahi Glass Co., Ltd.] | |
| Crosslinking agent: Polyisocyanate | 9.1 g |
| [Sumijule N3500 (non-volatile component content: | |
| 100%), Sumitomo Bayer Urethane, Inc.] | |
| Slipping agent: Alcohol modified silicone (X-22-2809, | 0.5 g |
| non-volatile component content: 66%, | |
| xylene-containing paste, Shin-etsu | |
| Chemical Company Ltd.] | |
| Catalyst: dibutyl tin dilaurate | 0.30 mg |
| [KS1260, Kyodo Yakuhin Co., Ltd.] | |

### EXAMPLE 3

The procedures of Example 1 were repeated except that the following modifications were made.

In the preparation of phosphor sheet (1), the following phosphor particles were employed:

Tetradecahedral stimulable phosphor particles
(BaF(Br_{0.85}I_{0.15}): Eu²⁺,

| | |
|---|---|
| Group I (mean particle size Dm: 8.0 μm) | 240 g |
| Group II (mean particle size Dm: 2.4 μm) | 60 g |

The protective film (thickness: 3 μm) was provided in the manner described in Example 2 using the polymer dispersion of the composition described in Example 2.

### COMPARISON EXAMPLE 1

The procedures of Example 1 were repeated except that the following modifications were made.

In the preparation of phosphor sheet (1), the following phosphor particles were employed:

Tetradecahedral stimulable phosphor particles (BaF(Br_{0.85}I_{0.15}):Eu²⁺,

Group I (mean particle size Dm: 6.7 μm) 125 g
Group II (mean particle size Dm: 2.8 μm) 125 g

The protective film (thickness: 3 μm, surface roughness Ra: 0.15 μm) was provided in the manner described in Example 2 using the polymer dispersion of the composition described in Example 2.

### COMPARISON EXAMPLE 2

The procedures of Example 1 were repeated except that the following modifications were made.

In the formation of protective film (5), a polymer solution of a saturated polyester resin (Byron 30 SS, Toyobo Company Ltd.) was coated on a PET film (thickness: 50 μm, Lumilar 6C-F53, Toray Company Ltd.) and dried to form an adhesive layer. Thus processed PET film was combined onto the phosphor layer via the adhesive layer to give a protective film (thickness: 50 μm). The protective film was then processed by an embossing roll to have a surface roughness Ra of 0.11 μm.

The second support was not incorporated into the radiation image storage panel.

### COMPARISON EXAMPLE 3

The procedures of Example 1 were repeated except that the following modifications were made.

In the preparation of phosphor sheet (1), the following phosphor particles were employed:

Tetradecahedral stimulable phosphor particles

Group I (mean particle size Dm: 6.7 μm) 210 g
Group II (mean particle size Dm: 2.8 μm) 90 g

The protective film (thickness; 3 μm, surface roughness Ra: 0.60 μm) was provided in the manner described in Example 2 using the polymer dispersion of the composition described in Example 2.

[Evaluation of Radiation Image Storage Panel]

The radiation image storage panels were evaluated in the following manner.

1) Universal Hardness

A Vickers indenter is pressed onto the protective film at 25° C. by means of a mini-scale hardness meter (Fischer's Scope H100C) under the conditions of a force (F) of 100 mN and a pressing period of 50 sec., and a depth (h) of the indent is measured. HU (in terms of N/mm²) is obtained from F and A(h) according to the aforementioned formula (1).

2) Deflection (Flexibility)

A radiation image storage panel is placed horizontally and supported at a line apart from one peripheral side of the storage panel by 20 cm. The deflection (in terms of mm) is determined by vertically measuring a distance from the position of supporting line to the downwardly inclined side.

3) Resistance to Physical Damage

The protective film of a radiation image storage panel is scratched by a sapphire needle having a top curvature radius of 1 mm φ at a rate of 1 cm/sec. The weight applied to the needle is varied from 0 to 400 g. The storage panel having been subjected to the scratching procedure is then exposed to X-rays (10 mR, tube voltage 80 kVp) and scanned with a semiconductor laser (wavelength: 660 nm). The stimulated emission radiated from the storage panel is collected by a light-receiving apparatus (photomultiplier having a resolution level S-5), converted into a series of electric signals to give a reproduced radiation image on a display. A relationship between the weight applied to the needle and a mark of the scratch appearing on the reproduced radiation image is examined. The weight at which the mark of the scratch is not observed on the reproduced radiation image is detected. The weight detected on each radiation image storage panel is set forth in Table 1 as a relative value.

4) Image Quality

A radiation image storage panel is exposed to X-rays (10 mR, tungsten tube, tube voltage 80 kVp) via an MTF chart and scanned with a semiconductor laser (wavelength: 660 nm) under such condition that the stimulating energy on the panel surface reaches 12 J/m². The stimulated emission radiated from the storage panel is collected by the light-receiving apparatus, converted into a series of electric signals to give a reproduced radiation image on a display. The sharpness is determined from the reproduced radiation image.

The radiation image storage panel is evenly exposed to X-rays (1 mR), and processed in the same manner to give a reproduced radiation image. From the reproduced radiation image, a Wiener spectrum for graininess is determined.

From the sharpness and graininess determined above, a detective quantum efficiency (DQE) at a space frequency 1 cycle/mm is obtained. The DQE is set forth in Table 1 in terms of a relative value. Note that since the graininess value depends on the dose of X-rays, the value is corrected into a value at a dose of 1 mR by monitoring the dose applied in the measurement.

6) Handling

A radiation image storage panel is encased in a cassette and then taken out of the cassette under room light. The protective film of the radiation image storage panel is then cleaned by means of a cotton cloth containing ethanol, and again is encased in the cassette. The series of these procedures are repeated 50 times. A reproduced radiation image is obtained using the radiation image storage panel having been subjected to the 50 times repeating procedures. The reproduced radiation image is then examined whether the image has an artifact or not. A reproduced radiation image on which an artifact is not observed is marked “good”, while reproduced radiation image on which an artifact is observed is marked “fail”.

The results are set forth in Table 1.

TABLE 1

| | Protective film | | Evaluation |
|---|---|---|---|
| | 1) surface hardness | Phosphor layer | 1) resistance |
| | 2) surface roughness | 1) B/P ratio | 2) DQE |
| | 3) thickness | 2) thickness | 3) handling |
| Ex. 1 | 1) 53 N/mm² | 1) 1/25 | 1) 300 |
| | 2) 0.20 μm | 2) 260 μm | 2) 100 |
| | 3) 8 μm | | 3) good |
| Ex. 2 | 1) 58 N/mm² | 1) 1/30 | 1) 290 |
| | 2) 0.15 μm | 2) 265 μm | 2) 110 |
| | 3) 3 μm | | 3) good |
| Ex. 3 | 1) 58 N/mm² | 1) 1/30 | 1) 300 |
| | 2) 0.20 μm | 2) 295 μm | 2) 120 |
| | 3) 3 μm | | 3) good |
| Com. Ex. 1 | 1) 45 N/mm² | 1) 1/25 | 1) 280 |
| | 2) 0.15 μm | 2) 265 μm | 2) 90 |
| | 3) 3 μm | | 3) good |
| Com. Ex. 2 | 1) 53 N/mm² | 1) 1/30 | 1) 330 |
| | 2) 0.11 μm | 2) 210 μm | 2) 75 |
| | 3) 50 μm | | 3) fail |
| Com. Ex. 3 | 1) 48 N/mm² | 1) 1/30 | 1) 290 |
| | 2) 0.60 μm | 2) 260 μm | 2) 95 |
| | 3) 3 μm | | 3) good |

Remarks: B/P means a weight ratio of binder to phosphor.

The deflection is as follows: Ex. 1 (0.5 mm), Ex. 2 (0.4 mm), Ex. 3 (0.4 mm), Com.Ex. 1 (0.5 mm), Com.Ex. 2 (approx. 20 mm), Com.Ex. 3 (0.4 mm).

The results set forth in Table 1 teach that the radiation image storage panels of Examples 1 to 3 which satisfy the requirements of the present invention regarding the surface hardness, surface roughness, and film thickness for the protective film shows a high resistance to scratch and gives a reproduced radiation image having a high quality as compared with the radiation image storage panels of Comparison Examples 1 to 3 not satisfying the requirements of the invention.

1. A radiation image storage panel comprising an energy-storing phosphor layer and a protective film arranged on one side of the phosphor layer in which the protective film has a surface of a universal hardness of 53 N/mm² or more, a surface roughness Ra in the range of 0.10 to 0.50 μm, and a thickness in the range of 1 to 40 μm.

2. The radiation image storage panel of claim 1, in which the universal hardness of the protective film is 55 N/mm² or more.

3. The radiation image storage panel of claim 1, which shows a deflection of less than 20 mm which is determined under such condition that the storage panel is supported at a line apart from one side of the storage panel by 20 cm.

4. The radiation image storage panel of claim 1, in which the phosphor layer comprises the energy-storing phosphor in the form of phosphor particles and a polymer binder and contains the phosphor particles 65 vol. % therein.

5. The radiation image storage panel of claim 4, in which a ratio of a content of the polymer binder to a content of the phosphor particles in the phosphor layer is not more than 1/25.

6. The radiation image storage panel of claim 1, in which the phosphor layer has a thickness of 250 μm or more.

7. The radiation image storage panel of claim 1, in which the phosphor layer has a light-reflecting layer on the side opposite the side on which the protective film is arranged, the light-reflecting layer showing a light reflectance of 70% or more at a wavelength corresponding to a peak wavelength of an emission spectrum of the energy-storing phosphor.
